(19) United States
(12) Patent Application Publication
(10) Pub. No.: US 2012/0180812 A1
(43) Pub. Date: Jul. 19, 2012

(54) Combination pool strainer and brush and method of use

(76) Inventor: Donald J. Holthusen, Gilbert, AZ (US)

(21) Appl. No.: 12/930,859

(22) Filed: Jan. 19, 2011

(51) Int. Cl. A47L 25/00; B08B 7/00

(52) U.S. Cl. 134/6; 15/106

(57) ABSTRACT

A combination pool strainer and brush for cleaning debris from a body of water and from a bottom surface of a water holding container including a frame defining an outer perimeter of an opening through which debris passes; a net for capturing debris integrally formed with the frame; a plurality of bristles that are integrally formed with the frame and cooperatively form a brush; a flange for scraping debris from a bottom surface of a container for holding a body of water, the flange integrally formed with the frame and formed at at least a 45 degree angle with respect to the plurality of bristles, wherein the flange protrudes outwardly from the frame at a least a 45 degree angle; and a handle attachment structure integrally formed with the frame on an opposing side of the frame from the flange adapted to receive an elongated handle.

### FIELD OF THE INVENTION

The present invention generally relates to a combination pool strainer and brush for use in the field of cleaning debris from underwater surfaces in man-made contained bodies of water such as swimming pools or hot tubs.

### BACKGROUND

Often underwater surfaces may be difficult to clean by conventional nets or brush devices. What is needed is a combination pool strainer and brush device used to clean underwater surfaces in a body of water and to remove debris from the body of water.

### SUMMARY

A combination pool strainer and brush device is provided for cleaning debris from a body of water and from a bottom surface of a container holding a body of water is disclosed. The device includes a frame having at least four sides defining an outer perimeter of an opening through which debris passes; a net for capturing debris integrally formed with the frame; a plurality of bristles that are integrally formed with the frame and cooperatively form a brush; a flange integrally formed with the frame and formed at at least a 45 degree angle with respect to the plurality of bristles, wherein the flange protrudes outwardly from the frame at a least a 45 degree angle; and a handle attachment structure integrally formed with the frame on an opposing side of the frame from the flange adapted to receive an elongated handle.

Additionally, a method of use is also disclosed herein.

### BRIEF DESCRIPTION OF THE DRAWINGS

These and other objects, features and advantages of the invention will become apparent from the following detailed description and the appended drawings in which:

FIG. 1 illustrates a top elevational view of a combination pool strainer and brush including an elongated handle in in accordance with one embodiment of the invention.

FIG. 2 illustrates a perspective view of a combination pool strainer and brush including an elongated handle in accordance with one embodiment of the invention.

FIG. 3 illustrates a perspective view of the of the combination pool strainer and brush shown in FIG. 2 having a cut-away portion exposing a plurality of bristle mounting holes.

FIG. 4 illustrates a bottom elevational view of a combination pool strainer and brush including an elongated handle in accordance with one embodiment of the invention.

FIG. 5 illustrates a bottom perspective view of combination pool strainer and brush including an elongated handle in accordance with one embodiment of the invention.

FIG. 6 illustrates a top elevational view of a combination pool strainer and brush including a detachable elongated handle in accordance with one embodiment of the invention.

FIG. 7 illustrates a perspective view of the combination pool strainer and brush shown in FIG. 6.

FIG. 8 illustrates a combination pool strainer and brush initially contacting a bottom surface of a pool in accordance with an embodiment of the invention.

FIG. 8A illustrates a detailed view of the brush and flange portion of the combination pool strainer and brush shown in FIG. 8.

FIG. 9 illustrates a combination pool strainer and brush in use where force is applied to the combination pool strainer and brush to cause the bristles to scrape against a bottom surface of a pool and further causes a flange to contact and further scrape the bottom surface of the pool.

FIG. 9A illustrates a detailed view of the brush and flange portions of the combination pool strainer and brush shown in FIG. 9.

FIG. 10 illustrates a top elevational assembly view of a combination pool strainer and brush including an elongated handle in accordance with an alternative embodiment of the invention.

FIGS. 11-12 illustrate a left-side perspective assembly view of a combination pool strainer and brush including an elongated handle in accordance with an alternative embodiment of the invention.

FIG. 13 illustrates a bottom elevational assembly view of a combination pool strainer and brush including an elongated handle and mounting anchors for mounting a complimentarily formed mating member to a frame in accordance with an alternative embodiment of the invention.

FIG. 14 illustrates a bottom perspective assembly view of a combination pool strainer and brush including an elongated handle and mounting anchors for mounting a complimentarily formed mating member to a frame in accordance with an alternative embodiment of the invention.

FIG. 15 illustrates a cutaway cross-sectional view of an encircled portion of the frame shown in FIG. 14 including a channel centrally disposed along an entire perimeter of a bottom peripheral wall of the frame along the bottom side of the frame.

### DETAILED DESCRIPTION OF THE INVENTION

In general a combination pool strainer and brush device for cleaning debris from a body of water and from a bottom surface of a container holding a body of water is disclosed. As used herein the term strainer may be interchangeably used to mean “net” or “mesh” used to capture debris therewith. The device includes a frame having at least four sides defining an outer perimeter of an opening through which debris passes; a net for capturing debris integrally formed with the frame; a plurality of bristles that are integrally formed with the frame and cooperatively form a brush; a flange integrally formed with the frame and formed at at least a 45 degree angle with respect to the plurality of bristles, wherein the flange protrudes outwardly from the frame at a least a 45 degree angle; and a handle attachment structure integrally formed with the frame on an opposing side of the frame from the flange adapted to receive an elongated handle.

In particular, the frame includes a top side from which the flange protrudes outwardly; a bottom side opposing the top side from which the net protrudes downwardly; an outer peripheral wall along an exterior portion of the frame, wherein the outer peripheral wall has a plurality of bristle mounting holes integrally formed therein wherein the flange and the handle attachment structure are integrally formed within the outer peripheral wall; and an inner peripheral wall along an interior portion of the frame to which the net is integrally formed therewith.

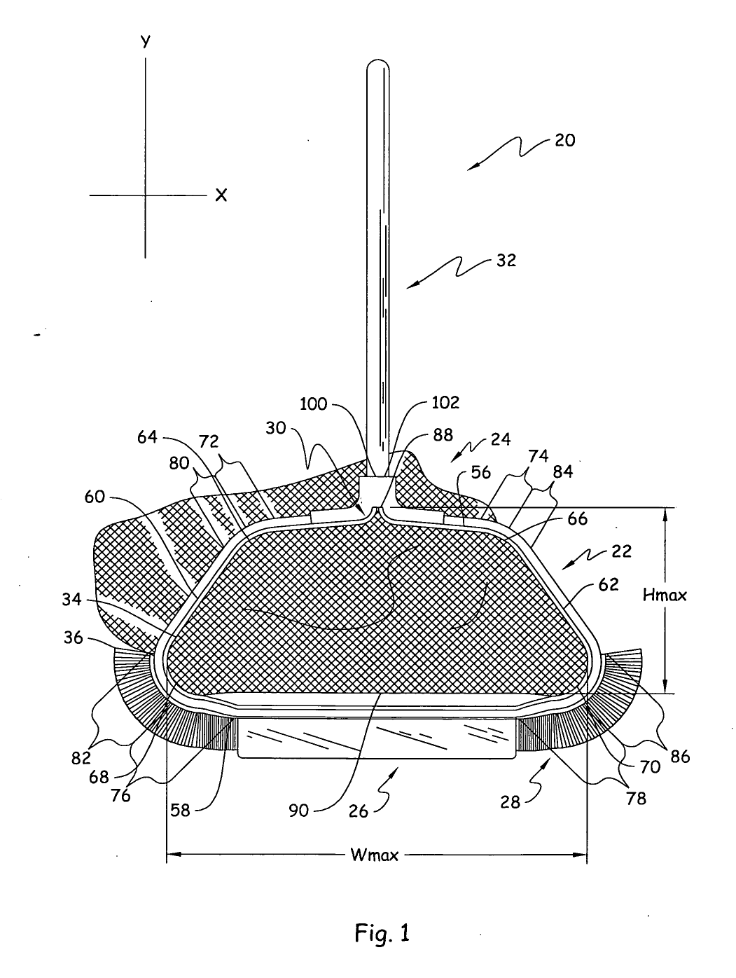

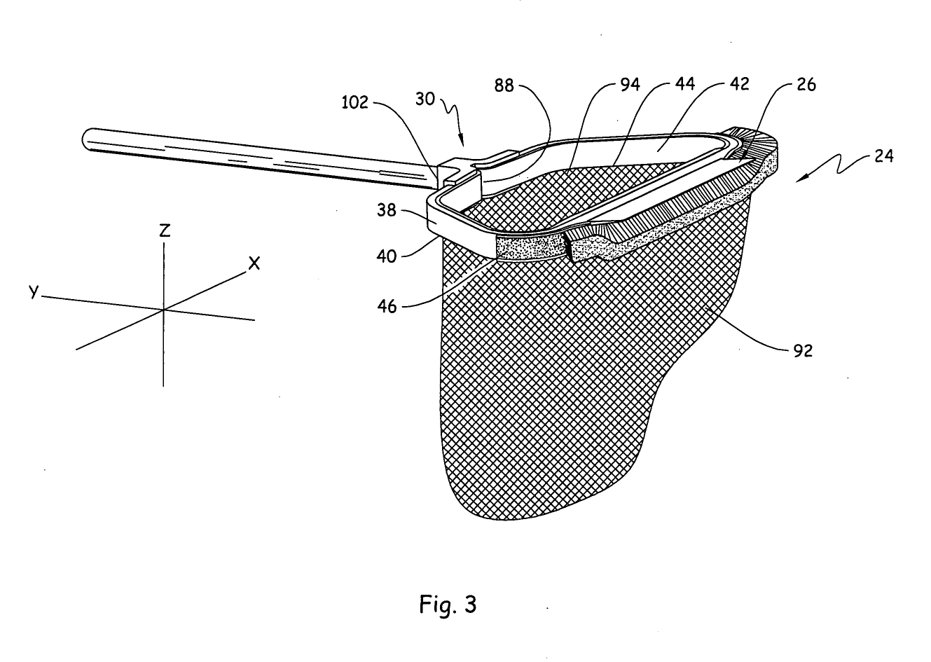

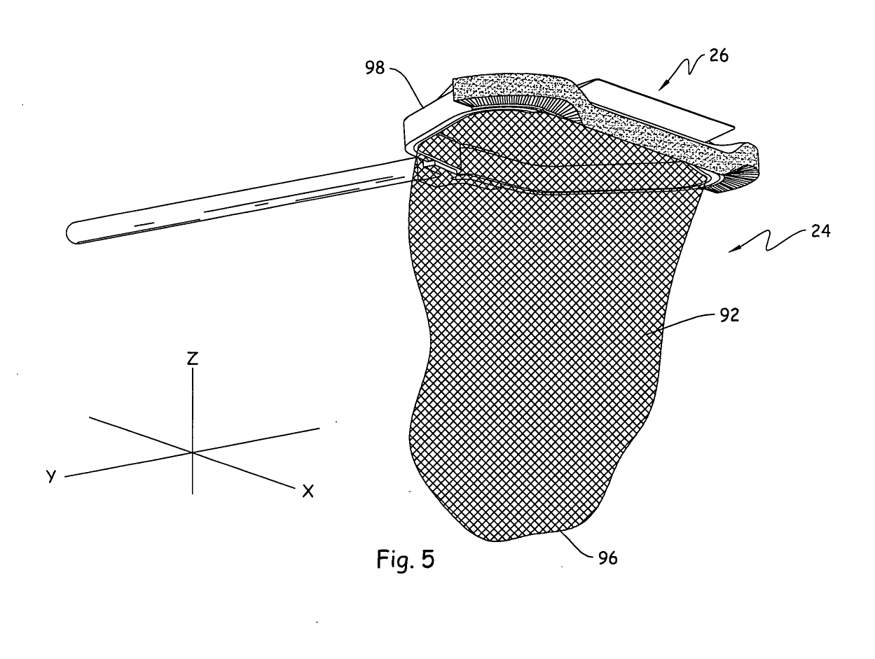

Referring to FIGS. 1-5 illustrate an embodiment of a combination pool strainer and brush device 20 that includes a frame 22, a net 24, a flange 26, a plurality of brush bristles 28, a handle attachment structure 30, and an elongated handle 32.

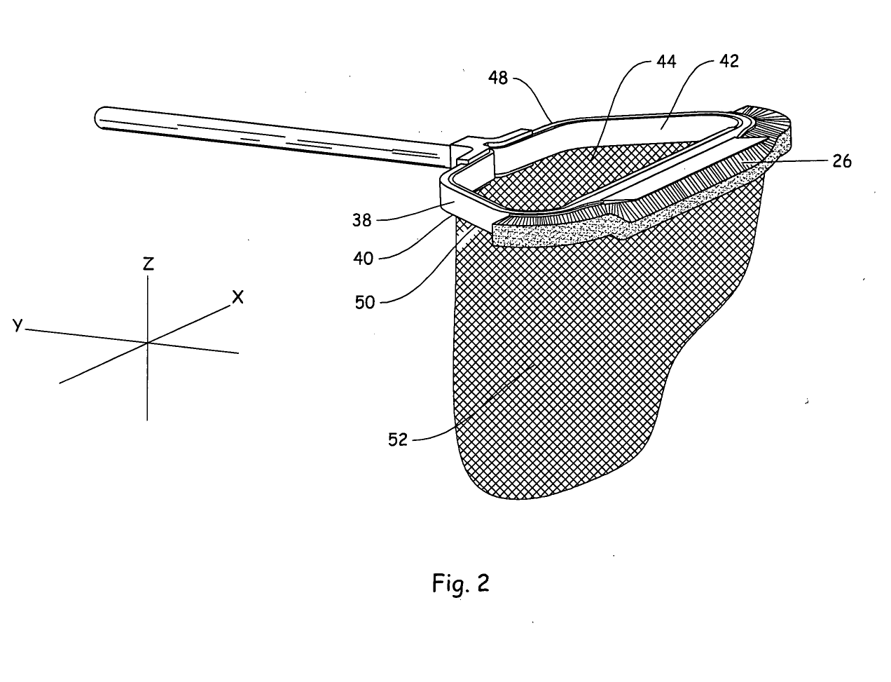

In an embodiment of the invention, the combination pool strainer and brush 20 includes a symmetrically shaped frame 22 defining an outer perimeter 34 of an opening 36 through which debris passes. The frame 22 includes an outer peripheral wall 38 along an exterior portion 40 of the frame 22 and an inner peripheral wall 42 along an interior portion 44 of the frame 22, wherein the outer peripheral wall 38 has a plurality of bristle mounting holes 46, the flange 26, and the handle attachment structure 30 integrally formed therewith. When the frame 22 is oriented along an X-Y plane as shown in FIGS. 2, 3, 5, the frame 22 has a top side 48 and a bottom side 50, wherein the net 24 protrudes outwardly and downwardly from the frame's 22 bottom side 50 along a Z-axis as shown in FIGS. 2, 3, 5 to catch debris that enters the opening 36 from the top side 48 of the frame 22 and flows through the opening 36 towards an interior portion 52 of the net 24 below the frame's 22 bottom side 50. The net 24 is integrally formed with the inner peripheral wall 42 of the frame 22 along an inner frame perimeter 54. A distance between the outer and inner peripheral walls 38, 42 of the frame 22 defines the frame 22 thickness T.

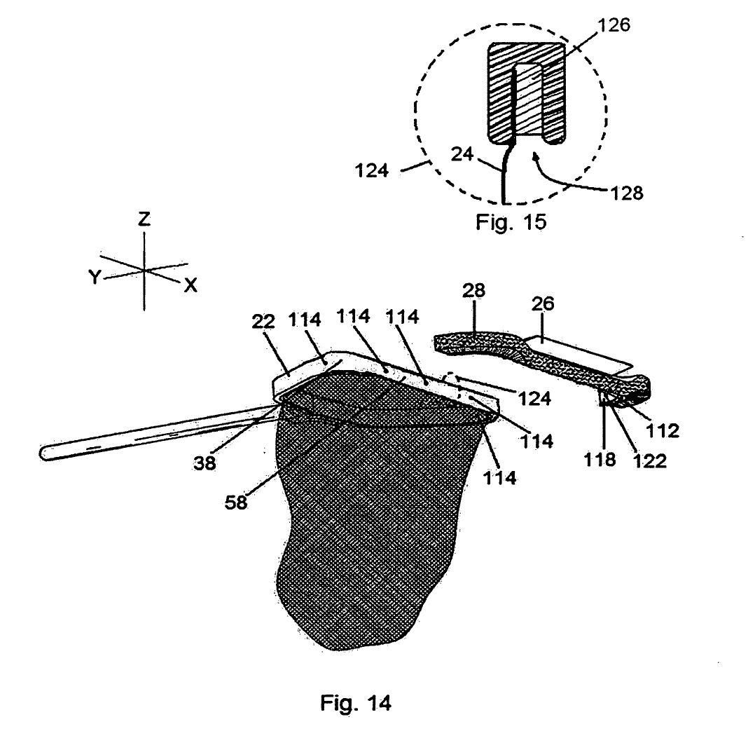

In an embodiment of the invention shown in FIGS. 14-15, and as shown in more detail in cutaway cross-sectional view of encircled portion 124, the frame further includes a channel 128 centrally disposed along an entire perimeter of a bottom peripheral wall of the frame along the bottom side of the frame, wherein the channel is adapted to receive and securely engage an inner reinforcement member 126 that operates to strengthen the frame structure. The inner reinforcement member may be made of any durable material capable of providing a rigid, non-deformable support for the frame that also can withstand extended exposure to wet environments and chemicals typically used in conventional pools. In an embodiment of the invention, as shown in FIG. 15, the net 24 is secured to the frame by securely affixing the net 24 to the frame between the inner reinforcement member and a side of the channel 128 disposed on the bottom side of the frame.

The frame includes two opposing substantially parallel sides, a first and a second parallel side 56, 58 that are orthogonal to the Y-axis that is in alignment with a longitudinal axis of the elongated handle as shown in FIG. 1, and a pair of opposing angled sides, a first and a second angled side 60, 62 between the first parallel side 56 and the second parallel side 58, wherein each of the opposing parallel sides 56, 58 have intersect a respective one of the pair of opposing angled sides 60, 62 thereby forming four interior corners 64, 66, 68, 70 at each intersection along the inner peripheral wall 42.

In an embodiment of the invention, a first interior corner 64 and an opposing second interior corner 66 are formed at a respective intersection of an associated one of the first parallel side 56 and the opposing angled sides 60, 62. A third interior corner 68 and an opposing fourth interior corner 70 are formed at a respective intersection of an associated one of the second parallel side 58 and the opposing angled sides 60, 62. The first interior corner 64 forms an adjacent and supplementary angle with the third interior corner 68. The second interior corner 66 forms an adjacent and supplementary angle with the fourth interior corner 70.

In an embodiment of the invention, the parallel and angled sides 56, 58, 60, 62 intersect to form an approximate shape of an isosceles trapezoid.

In an embodiment of the invention, the frame 22 is the approximate shape of an isosceles trapezoid and may be constructed of a rigid yet resilient material that is slightly flexible to torque when force is applied to the frame as needed to capture debris but rigid enough to maintain fixed dimensions when not in use and to withstand extended exposure to wet environments and conventional chemicals used in pools such as, but not limited to plastic.

In an embodiment of the invention, the first opposing parallel side 56 includes first and second arcuate end sections 72, 74, and the second parallel side 58 includes third and fourth arcuate end sections 76, 78. Additionally, the first angled side includes fifth and sixth arcuate end sections 80, 82, and the second angled side includes seventh and eighth arcuate end sections 84, 86. The four interior corners 64, 66, 68, 70 are arcuate and are formed by the intersection of each of the arcuate end sections, wherein a first arcuate corner 64 is formed by the intersection of the first and the fifth arcuate end sections 72, 80 of the first parallel side 56 and the first angled side 60 respectively, a second arcuate corner 66 is formed by the intersection of the second and seventh arcuate end sections 74, 84 of the first parallel side 56 and the second angled side 62 respectively, a third arcuate corner 68 is formed by the intersection of the third and sixth arcuate end sections 76, 82 of the second parallel side 58 and the first angled side 60 respectively, and a fourth arcuate corner 70 is formed by the intersection of the fourth and eighth arcuate end sections 78, 86 of the second parallel side 58 and the second angled side 62 respectively, wherein the midpoint of each arcuate corner defines the intersection point of each of the respective arcuate end sections associated with each respective arcuate corner.

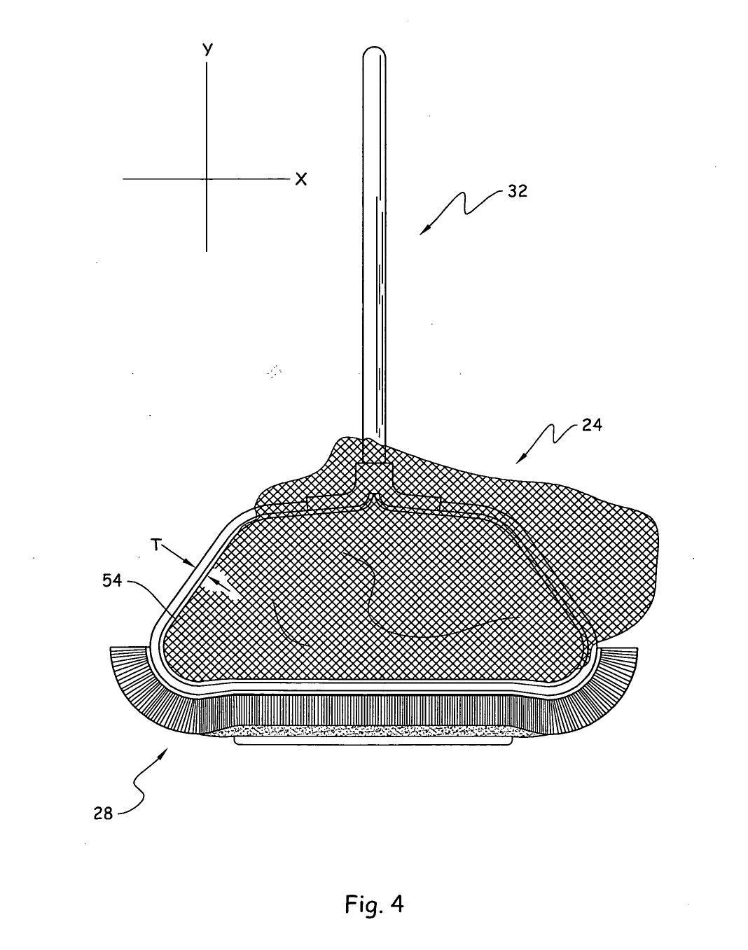

In an embodiment of the invention, the first parallel side 56 is a first short parallel side proximal to the frame handle attachment structure 30, and the second parallel side 58 is a second long parallel side that opposes the first short parallel side 56 and has a longer length than the first short parallel side 56, and wherein a midpoint 88, 90 of each of the two opposing parallel sides 56, 58, respectively are aligned along the Y-axis as shown in FIGS. 1, 4. In an embodiment of the invention, the frame handle attachment structure 30 attaches to the first short parallel side 56 at the midpoint 88 of the first short parallel side 56. The frame 22 further includes an outer peripheral wall 38 that contours the inner peripheral wall 42 along an exterior portion 40 of the frame 22.

The frame opening 36 has a maximum height Hmax defined by a predetermined distance between the midpoints 88, 90 of each of the opposing parallel sides 56, 58 in a direction parallel to the Y-axis as shown in FIG. 1, and a maximum width Wmax defined by a maximum distance between the arcuate end sections 82, 86 of the third and fourth corners 68, 70 in a direction parallel with the X-axis orthogonal to the Y-axis as shown in FIG. 1.

In an embodiment of the invention with arcuate corners, a plurality of bristle mounting holes 46 are adapted to receive a plurality of brush bristles 28 disposed within fifth and sixth arcuate end sections 80, 82 and the seventh and eighth arcuate end sections 84, 86 of the respective opposing angled sides 60, 62 of the frame 22 along the outer peripheral wall 38. In an embodiment of the invention without arcuate corners, a plurality of bristle mounting holes are disposed within each of the opposing angled sides of the frame. Additionally, a plurality of bristle mounting holes 46 are further disposed within the long parallel side 58 of the frame 22.

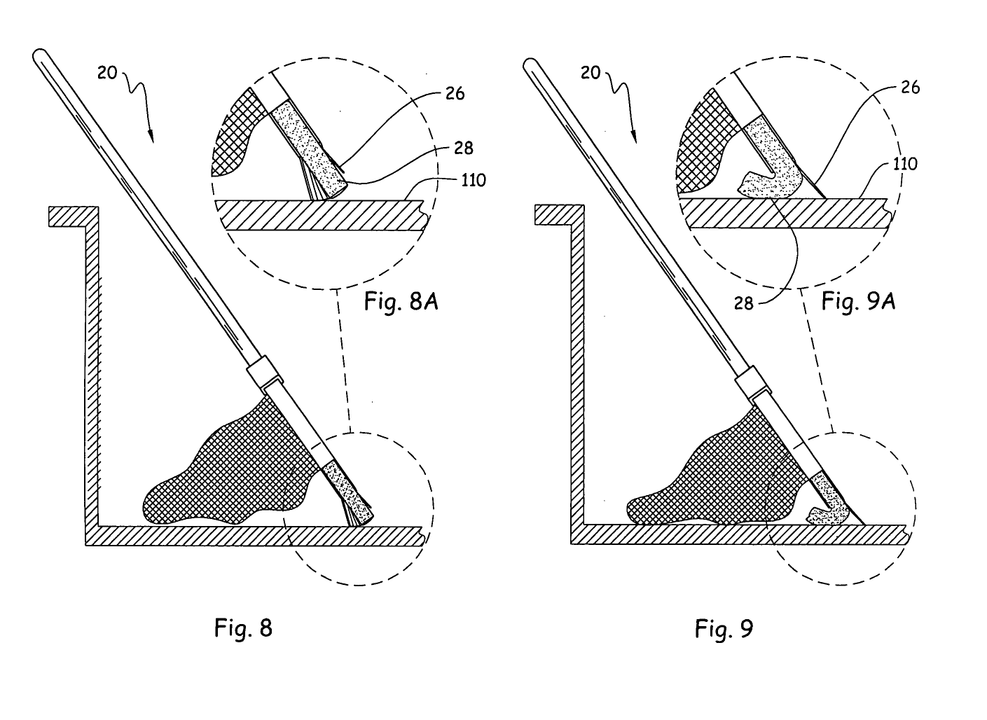

A plurality of bristles 28 may be constructed of relatively stiff, yet flexible, resilient and waterproof material such as, but not limited to, plastic and are securely disposed or embedded within each of the bristle mounting holes 46, wherein when all of the plurality of bristles 28 are mounted on within the bristle mounting holes 46, the plurality of bristles 28 cooperatively form a brush having a substantially rectangular box-like cross section or profile as shown in FIGS. 8, 8A, 9, and 9A. When viewed from a bottom view as shown in FIG. 4, the brush has a fan-like contour.

The net 24 of the device includes a mesh material 92 having an open end 94 and a closed tapered end 96. The open end 94 has an outer contour 98 defined by an approximate shape of an isosceles trapezoid corresponding to the parallel and angled sides 56, 58, 60, 62 of the frame 22. The closed tapered end 96 of the net 24 extends a predetermined maximum distance from the open end 94 of the net 24 in a direction outwardly and downwardly from the frame's bottom side 50 along a Z-axis as shown in FIGS. 2, 3, 5. The net 24 may be constructed from a flexible, resilient mesh such as, but not limited to, nylon netting. In an embodiment of the invention including an inner channel and inner reinforcement member, the net 24 may be secured at the open end 94 sandwiched between the inner reinforcement member and the frame.

The flange 26 includes a first and a second planar surface, and extends from the long parallel side 58 of the frame 22 and from the top side 48 of the frame 22 at an approximate 45 degree angle with respect to long parallel side of the frame along the X-Y plane as shown in FIGS. 1, 2, 3, 5. The first planar surface of the flange is flush with the outer peripheral wall along the long parallel side of the frame such that the flange extends away from the X-Y plane at an approximate 45 degree angle and in a direction opposite to the first parallel side of the frame and in a direction towards the tapered end of the net or towards the bottom side of the frame.

The flange 26 may be uniformly shaped in the shape of a rectangle but any elongated geometric shape would be appropriate and may further include a wedge shape having a tapered edge that allows the flange to contact a bottom surface of a container containing a body of water and scrape the bottom surface, thereby dislodging debris such as dirt or leaves embedded on a bottom surface of a pool from the bottom surface.

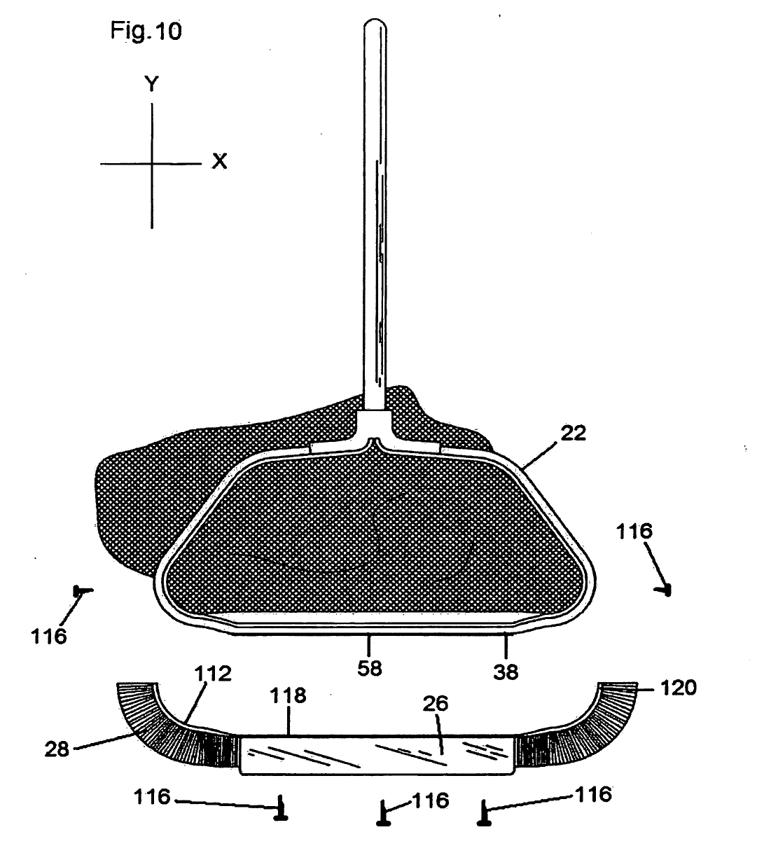

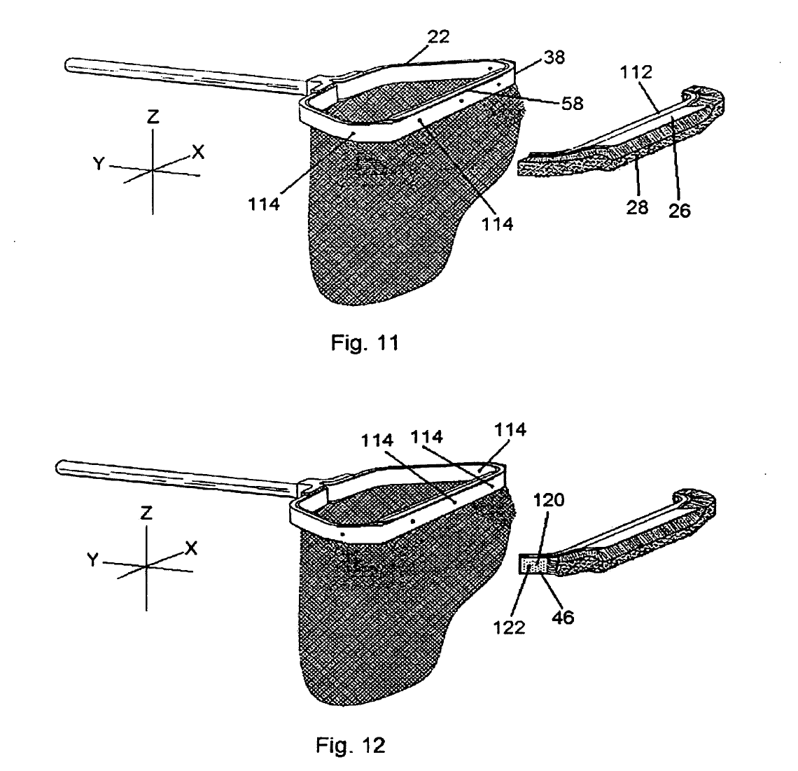

FIGS. 10-14 illustrate an alternative embodiment of the invention including a complementarily formed mating member that contours a portion of the outer peripheral wall along a long parallel side of the frame and includes a brush and flange integrally formed therewith. Referring to FIGS. 10-14, instead of mounting directly to the frame 22, the flange 26 and bristle mounting holes 46 may be integrally formed with a complementarily formed mating member 112 that contours a portion of the outer peripheral wall 38 along the long parallel side 58 of the frame 22 and opposing exterior portions of the third and fourth arcuate corners 68, 70, wherein the portion of the outer peripheral wall along the second parallel side 58 of the frame 22 includes coordinated mounting holes 114 disposed therewithin to receive the complementarily formed mating member 112 via one or more mount anchors 116. The mating member 112 includes an inner surface 118 flush with the portion of the outer peripheral wall 38 along the long parallel side 58 of the frame 22, and an outer surface 120 opposing the inner surface, including a plurality of bristle mounting holes 46 (shown in FIG. 12) disposed therewithin for receiving the plurality of bristles 28 forming the brush and one or more mount anchor mount holes 122 disposed therethrough for receiving one or more mount anchors 116 to secure the mating member 112 to the portion of the outer peripheral wall along the long parallel side 58 of the frame 22.

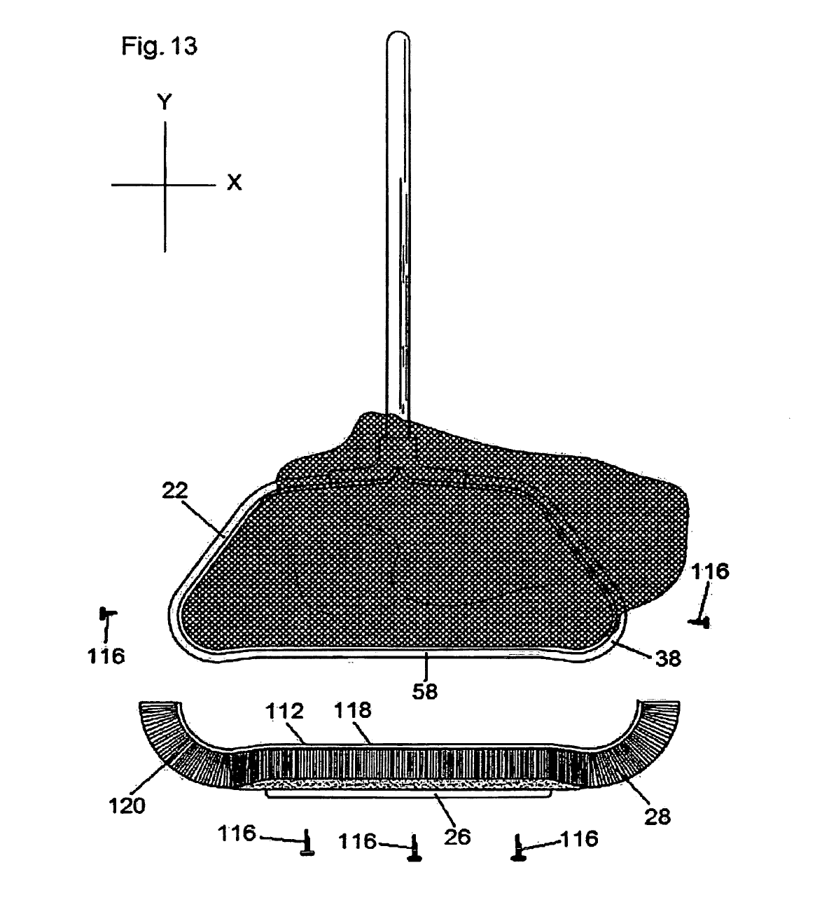

As shown in FIGS. 10 and 13, in an embodiment of the invention, a plurality of mount anchors 116 are disposed through the coordinated first mounting holes 114 in the outer peripheral wall 38 and further through the second mounting holes 122 in the mating member 112 to secure the mating member 112 to the frame 22. The plurality of mount anchors 116 may be any type of threaded fastener adapted to fixedly secure two elements together and may further include a nut, wherein the plurality of mount anchors may be constructed of threaded, metal cylinders such as, but not limited to, stainless steel bolts and nuts or may be constructed of a durable plastic material.

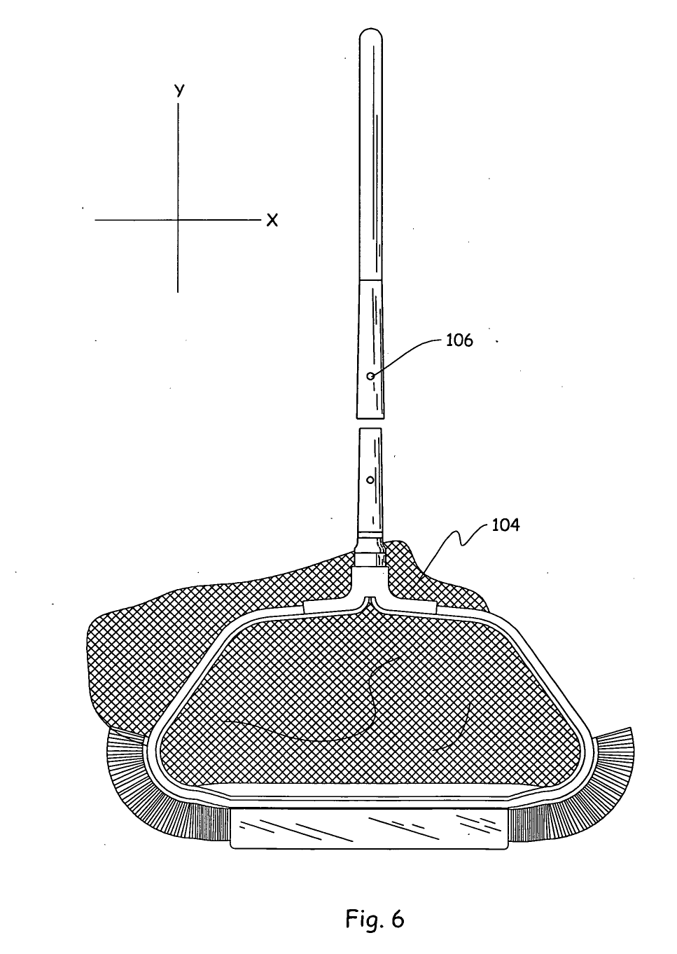

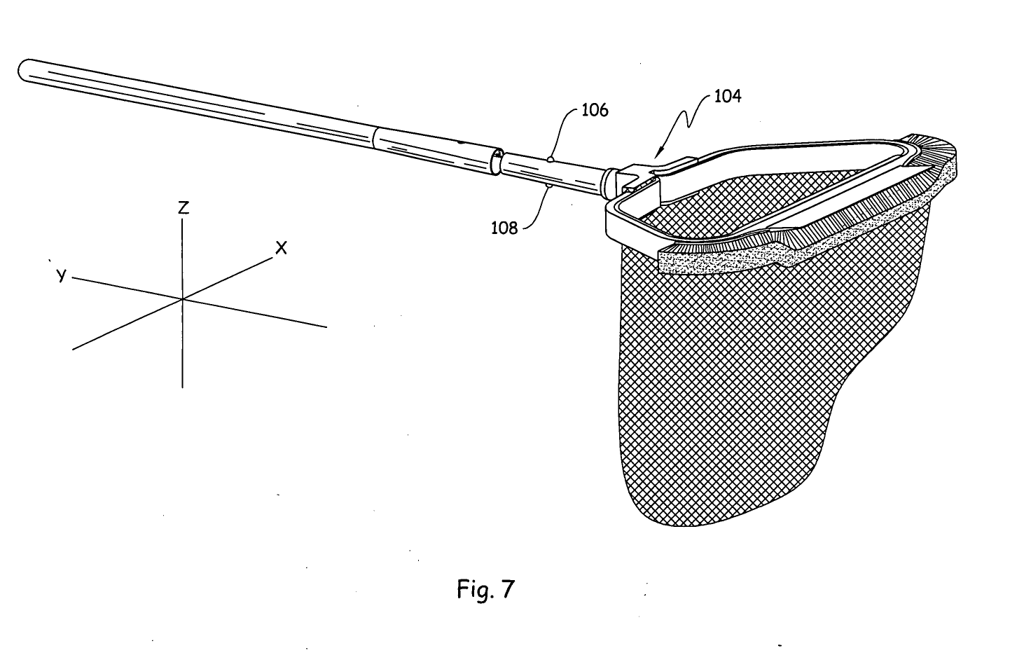

The handle attachment structure 30 extends from the outer peripheral wall 38 and from the midpoint 88 of the short parallel side 56 of the frame 22 in the direction of the Y-axis as shown in FIG. 1. The handle attachment structure 30 may be adapted to removably secure an elongated handle to the frame 22 by means of a handle receiving hole 100 the approximate diameter of an opposing end 102 of an elongated handle 32. Alternatively, a handle attachment structure 104 by means of opposing retractable handle mounts 106, 108 as shown in FIGS. 6, 7.

In use, the combination pool strainer and brush device 20 may clean a body of water such as, but not limited to, a swimming pool, hot tub, or pond as well as the bottom surface of a body of water holding container (partially shown in FIGS. 8, 8A, 9, 9A). The device 20 may be oriented by submerging the device 20 such that a user rests the flange 26 and the plurality of bristles 28 on the bottom surface of a body of water holding container while maintaining a grip on the elongated handle 32 as shown in FIG. 8 and in more detail in FIG. 8A. A user may exert a substantially downward force having both a vertical and lateral force magnitude vector on the device 20 such that the plurality of bristles 28 flex in the direction of the net 24 and such that the flange 26 edge frictionally engage the bottom surface of the body of water as is shown in FIG. 9 and in more detail in FIG. 9A. A user may then exerts force on the device 20 such that the flange 26 moves in the lateral direction of the lateral force magnitude vector exerted on the device 20 and scrapes the bottom surface 110 of a body of water holding container. The movement of the device 20 causes hydrodynamic motion within the water, such that a thrust is created in the water through which the device 20 is moving. The thrust of water exerts a pulling force on debris located near the opening of the net in a transverse direction to the movement of the device 20 and thus “pulls” the debris submerged in the water towards an interior portion of the net. Thus, the forces exerted on the device 20 cause debris such as, but not limited to, leaves to be pulled into the opening 36 of the net 24 and to be retained in the net 24 via the frame's 22 approximately isosceles trapezoidal shape. Simultaneously, the plurality of bristles 28 cleans the bottom surface 110 of a body of water when a fore or aft motion is applied to the device thereby causing a scrubbing effect of the bristles 28 against the bottom surface 110 and agitation of the water surrounding the brush, thereby dislodging debris such as dirt or leaves embedded on a bottom surface 110 of a pool from the bottom surface 110.

While several aspects have been presented in the foregoing detailed description, it should be understood that a vast number of variations exist and these aspects are merely an example, and it is not intended to limit the scope, applicability or configuration of the invention in any way. Rather, the foregoing detailed description provides those of ordinary skill in the art with a convenient guide for implementing a desired aspect of the invention and various changes can be made in the function and arrangements of the embodiments of the invention without departing from the spirit and scope of the appended claims.

What is claimed is:

1. A combination pool strainer and brush for cleaning debris from a body of water and from a bottom surface of a container holding a body of water comprising:
a frame having at least four sides defining an outer perimeter of an opening through which debris passes;
a net for capturing debris integrally formed with the frame;
a plurality of bristles that are integrally formed with the frame and cooperatively form a brush;
a flange for scraping debris from a bottom surface of a container for holding a body of water, the flange integrally formed with the frame and formed at at least a 45 degree angle with respect to the plurality of bristles, wherein the flange protrudes outwardly from the frame at a least a 45 degree angle; and
a handle attachment structure integrally formed with the frame on an opposing side of the frame from the flange adapted to receive an elongated handle.

2. The combination pool strainer and brush of claim 1, wherein the frame comprises:
a top side from which the flange protrudes outwardly;
a bottom side opposing the top side from which the net protrudes downwardly;
an outer peripheral wall along an exterior portion of the frame, wherein the outer peripheral wall has a plurality of bristle mounting holes integrally formed therein wherein the flange and the handle attachment structure are integrally formed within the outer peripheral wall; and
an inner peripheral wall along an interior portion of the frame.

3. The combination pool strainer and brush of claim 2, wherein a distance between the outer and inner peripheral walls of the frame comprises: a frame thickness T.

4. The combination pool strainer and brush of claim 2, wherein an outer peripheral wall contours the inner peripheral wall along an exterior portion of the frame.

5. The combination pool strainer and brush of claim 2, wherein the net catches debris that enters the opening from the top side of the frame and flows through the opening towards an interior portion of the net below the bottom side of the frame.

6. The combination pool strainer and brush of claim 2, wherein the net is integrally formed with the inner peripheral wall of the frame.

7. The combination pool strainer and brush of claim 2, the frame further comprises:
a channel centrally disposed along an entire perimeter of a bottom peripheral wall along the bottom side of the frame, and
an inner reinforcement member securely engaged within the channel that operates to strengthen the frame structure by providing a rigid, non-deformable support for the frame that withstands extended exposure to wet environments and chemicals used in conventional pools, wherein the net is received within the channel and is affixed to the frame sandwiched between the inner reinforcement member and a side of the channel disposed on the bottom side of the frame.

8. The combination pool strainer and brush of claim 2, wherein the frame further comprises:
a first parallel side;
a second opposing the first parallel side, wherein the first and second parallel sides are orthogonal to a Y-axis in alignment with a longitudinal axis of the handle attachment structure;
a first angled side; and
a second angled side opposing the first angled side, wherein the first and second angled sides are each respectively disposed between the first parallel side and the second parallel side, and wherein each of the opposing parallel sides intersect a respective one of the pair of opposing angled sides to form four interior corners at each intersection along the inner peripheral wall.

9. The combination pool strainer and brush of claim 8, wherein the first parallel side is a first short parallel side proximal to the frame handle attachment structure, and wherein the second parallel side is a second long parallel side having a longer length than the first short parallel side, and wherein a respective midpoint of each of the first short and second long and opposing parallel sides are aligned along the Y-axis, and wherein the frame handle attachment structure attaches to the first short parallel side at the midpoint of the first short parallel side.

10. The combination pool strainer and brush of claim 9, wherein the flange comprises:
a first and a second planar surface, and
a wedge shape including a tapered edge that allows the flange to contact a bottom surface of a container containing a body of water and scrape the bottom surface, thereby dislodging debris embedded on a bottom surface of a pool from the bottom surface, wherein the flange extends from the long parallel side of the frame and from the top side of the frame at an approximate 45 degree angle with respect to the long parallel side of the frame along an X-Y plane, and wherein the first planar surface of the flange is flush with the outer peripheral wall along the long parallel side of the frame such that the flange extends away from the X-Y plane at an approximate 45 degree angle and in a direction opposite to the first parallel side of the frame and in a direction towards the bottom side of the net.

11. The combination pool strainer and brush of claim 9, further comprising:
a plurality of bristle mounting holes disposed within each of the opposing first and second angled sides of the frame, and within the second long parallel side of the frame, wherein the plurality of bristles are securely embedded within each of the bristle mounting holes, wherein when the plurality of bristles cooperatively form a brush having a substantially rectangular box-like cross section.

12. The combination pool strainer and brush of claim 8, wherein the four interior corners comprise:
a first interior corner formed at a respective intersection of the first parallel side and the first angled side;
a second interior corner opposing the second interior corner formed at a respective intersection of the first parallel side and the second angled side;
a third interior corner formed at a respective intersection of the second parallel side and the first angled side;
a fourth interior corner opposing the third interior corner formed at a respective intersection of the second parallel side and the second angled sides, wherein the first interior corner forms an adjacent and supplementary angle with the third interior corner, and wherein the second interior corner forms an adjacent and supplementary angle with the fourth interior corner.

13. The combination pool strainer and brush of claim 8, wherein the first parallel side includes a first and a second arcuate end section, the second parallel side includes a third and a fourth arcuate end section, the first angled side includes a fifth and sixth arcuate end section, and the second angled side includes a seventh and an eighth arcuate end section, and wherein the four interior corners are arcuate and are formed by the intersection of each of the arcuate end sections comprising
a first arcuate corner formed by the intersection of the first and the fifth arcuate end sections of the first parallel side and the first angled side respectively,
a second arcuate corner formed by the intersection of the second and seventh arcuate end sections of the first parallel side and the second angled side respectively,
a third arcuate corner formed by the intersection of the third and sixth arcuate end sections of the second parallel side and the first angled side respectively, and
a fourth arcuate corner formed by the intersection of the fourth and eighth arcuate end sections of the second parallel and the second angled side respectively, wherein midpoint of each arcuate corner defines the intersection point of each of the respective arcuate end sections associated with each respective arcuate corner.

14. The combination pool strainer and brush of claim 13, further comprising:
a complementarily formed mating member that contours a portion of the outer peripheral wall along the second parallel side of the frame and opposing exterior portions of the third and fourth arcuate corners, wherein the portion of the outer peripheral wall along the second parallel side of the frame includes one or more coordinated first mounting holes disposed therewithin to receive the complementarily formed mating member via one or more mount anchors, wherein the complementarily formed mating member includes
an inner surface flush with a portion of the outer peripheral wall along the second parallel side of the frame;
an outer surface opposing the inner surface including
a plurality of bristle mounting holes disposed therewithin for receiving the plurality of bristles forming a brush, and
one or more mount anchor second mounting holes disposed therethrough for receiving respective one or more mount anchors to secure the complementarily formed mating member to the portion of the outer peripheral wall along the second parallel side of the frame; and
a plurality of mount anchors disposed through the coordinated first mounting holes in the portion of the outer peripheral wall along the second parallel side and further through the second mounting holes in the complementarily formed mating member to secure the mating member to the frame, and wherein the flange is integrally formed with the complementarily formed mating member

15. The combination pool strainer and brush of claim 13, wherein the frame opening comprises:
a maximum height Hmax defined by a predetermined distance between a respective midpoint of each of the opposing parallel sides in a direction parallel to the Y-axis; and
a maximum width Wmax defined by a maximum distance between the third and sixth arcuate end sections of the third corner and the fourth and eighth arcuate end sections of the fourth cornersin a direction parallel with an X-axis orthogonal to the Y-axis.

16. The combination pool strainer and brush of claim 13, further comprising:
a plurality of bristle mounting holes adapted to receive a plurality of brush bristles disposed within the second parallel side, fifth and sixth arcuate end sections and the seventh and eighth arcuate end sections of the respective opposing first and second angled sides of the frame along the outer peripheral wall, wherein the plurality of bristles are securely embedded within each of the bristle mounting holes, wherein when the plurality of bristles cooperatively form a brush having a substantially rectangular box-like cross section.

17. The combination pool strainer and brush of claim 8, wherein the parallel and angled sides intersect to form an approximate shape of an isosceles trapezoid.

18. The combination pool strainer and brush of claim 17, wherein the net comprises
a mesh material including
an open end and
a closed tapered end, wherein the open end has an outer contour defined by an approximate shape of an isosceles trapezoid corresponding to the first and second sides and the third and fourth angled sides of the frame, wherein the closed tapered end of the net extends a predetermined maximum distance from the open end of the net in a direction outwardly and downwardly from the frame's bottom side along a Z-axis orthogonal to the Y-axis.

19. The combination pool strainer and brush of claim 8, wherein the frame comprises:
a rigid yet resilient material that is slightly flexible to torque when force is applied to the frame as needed to capture debris but rigid enough to maintain fixed dimensions when not in use and to withstand extended exposure to wet environments and conventional chemicals used in pools.

20. A method of using a combination pool strainer and brush for cleaning debris from a body of water and from a bottom surface of a container holding a body of water comprising:
providing a combination pool strainer and brush including a frame having at least four sides defining an outer perimeter of an opening through which debris passes, a net for capturing debris integrally formed with the frame, a plurality of bristles integrally formed with the frame that cooperatively form a brush, a flange having a flange edge, the flange integrally formed with the frame and formed at at least a 45 degree angle with respect to the plurality of bristles, wherein the flange protrudes outwardly from the frame at a least a 45 degree angle; a handle attachment structure integrally formed with the frame on an opposing side of the frame from the flange adapted to receive an elongated handle, and an elongated handle securely attached to the handle attachment structure;
submerging the device to rest the flange and the plurality of bristles on the bottom surface of a body of water holding container while maintaining a grip on the elongated handle;
exerting a substantially downward force having both a vertical and lateral force magnitude vector on the elongated handle such that the plurality of bristles flex in the direction of the net and such that the flange edge frictionally engages the bottom surface of the body of water;
exerting a force on the elongated handle such that the flange moves in a lateral direction of the force magnitude vector exerted on the elongated handle and scrapes the bottom surface of a body of water holding container;
moving the elongated handle to cause hydrodynamic motion within the water enough to create a thrust of water that thereby exerts a pulling force on debris located near the opening of the net in a transverse direction to the movement of the elongated handle and thus pulls the debris submerged in the water towards an interior portion of the net; and
using the plurality of bristles to simultaneously clean the bottom surface of a body of water when the thrust is created in the water.
